(19) United States
(12) Patent Application Publication
(10) Pub. No.: US 2025/0257887 A1
(43) Pub. Date: Aug. 14, 2025

(54) FILTER ASSEMBLY AND AIR PURIFIER INCLUDING SAME

(71) Applicant: COWAY CO., LTD., Gongju-si (KR)

(72) Inventors: Young Gun CHO, Seoul (KR); Yu Young NAM, Seoul (KR); Jun Hyoung BAE, Seoul (KR); Joon Young CHOI, Seoul (KR); Hyun Kyu LEE, Seoul (KR); Wang Ki CHAE, Seoul (KR); Jong Min SHIN, Seoul (KR); Jun Been SON, Seoul (KR)

(73) Assignee: COWAY CO., LTD., Gongju-si (KR)

(21) Appl. No.: 18/867,138

(22) PCT Filed: May 26, 2023
(86) PCT No.: PCT/KR2023/007300

§ 371 Date: Nov. 19, 2024

(30) Foreign Application Priority Data
May 30, 2022 (KR) 10-2022-0065808
May 30, 2022 (KR) 10-2022-0065902
Jun. 29, 2022 (KR) 10-2022-0079871
Jun. 29, 2022 (KR) 10-2022-0079931

(51) Int. Cl. F24F 8/108; B01D 46/12; B01D 46/44; F24F 11/72

(52) U.S. Cl. CPC F24F 8/108; B01D 46/12; B01D 46/44; F24F 11/72

(57) ABSTRACT

An air purifier include: a frame; a filter assembly detachably mounted in the frame for filtering air; a fan assembly providing a blowing force to move air from an outside of the frame to an inside of the frame; and a controller for controlling an operation of the fan assembly. The filter assembly includes: a plurality of filter members of different types; and a filter holder supporting the plurality of filter members and including a first filter region and a second filter region which are separate from each other.

### TECHNICAL FIELD

The present disclosure relates filter assembly and an air purifier including the same.

### BACKGROUND ART

In general, an air purifier is a device that sucks in polluted indoor air and purifies indoor air by filtering out dust, odor particles, and the like from the incoming air, to deliver clean air. Such air purifiers work by drawing in contaminated air, filtering it, and then discharging the cleaned air back into the environment, thereby purifying the indoor air.

Meanwhile, air purifiers may include a filter for removing dust, odor particles, and other impurities from the incoming air, and a frame that allows for replaceable filter mounting. Additionally, multiple types of filters with distinct functions, such as HI A filter deodorization filters, and functional filters, may be provided within the air purifier.

Korean Patent Publication No. 10-2016-0099145, “Air Purifier” (Patent Document 1), discloses a frame supporting a first air purification filter, second air purification filter, functional filter, and other filters for air filtration.

However, the air purifier of Patent Document 1 faces difficulties in replacing multiple filters as each filter must be individually detached and mounted onto the frame. For instance, to replace multiple filters, the operator must detach each filter from the frame and then remount each filter onto the frame individually. This process is time-consuming and cumbersome, requiring the operator to manage multiple filters separately, which can be inconvenient and inefficient.

Thus, there is a need for an air purifier that includes a filter assembly capable of easily attaching and detaching multiple types of filters simultaneously to and from the frame, allowing for convenient handling and transportation of the filters.

Meanwhile, Korean Patent Publication No. 10-2018-0138247, “Air Purifier with Dual Fans for Different Discharge Directions” (Patent Document 2), discloses an air purifier equipped with an upper dual-directional fan and a lower dual-directional fan to circulate air.

However, in Patent Document 2, both the upper and lower fans operate at the same rotation speed, which may result in varying differential pressures on the upper and lower filters when multiple types of filters are arranged vertically. For example, if an activated carbon filter is positioned at the lower part and a mesh-type filter is positioned at the upper part, the differential pressures across these filters will differ even if the upper and lower fans operate at the same rate. Consequently, the upper filter may reach its replacement cycle more quickly, which causes the air purifier's cleaning efficiency to decrease.

Additionally, in Patent Document 2, since the air flows toward both the upper and lower fans after passing through the filter, vortices may form between the filters and the fans. This results in prolonged air retention within the space between the filters and fans, which lengthens airflow time and reduces the purification efficiency of the air purifier.

Accordingly, there is a need for an air purifier that can control multiple fans to ensure that none of the filters reach their replacement cycle prematurely, even with multiple filters in place.

Furthermore, there is a need for a filter assembly and an air purifier including the same, capable of preventing vortex formation between the filter and the fan, thereby enhancing the purifier's cleaning efficiency.

### DETAILED DESCRIPTION OF INVENTION

### Technical Problems

One embodiment of the present disclosure, developed with consideration of the aforementioned background, aims to provide an air purifier capable of mounting or detaching various types of filter members into or from a frame at once.

Furthermore, one embodiment of the present disclosure seeks to provide an air purifier that prevents the filter assembly from being mounted into the frame in an incorrect orientation.

Additionally, one embodiment of the present disclosure aims to offer an air purifier that controls a first fan unit, facing a first filter region, to operate at a higher rotational speed than a second fan unit. This allows air to smoothly pass through the first filter region even if a higher differential pressure is applied to it compared to the second filter region.

Moreover, one embodiment of the present disclosure seeks to provide a filter assembly and an air purifier including the same, which prevents vortex formation between the filter assembly and the frame by having a plurality of wall portions supported on the protruding ribs of the frame.

### Technical Solution

In accordance with one aspect of the present disclosure, there is provided a filter assembly including: a plurality of filter members of different types for filtering contaminants from flowing air; and a filter holder supporting the plurality of filter members and including a first filter region and a second filter region that are separated without overlapping when viewed in a direction of air flow, wherein the filter holder includes: a first edge portion forming at least a portion of the first filter region; a second edge portion forming at least a portion of the second filter region; and a partitioning portion dividing the first filter region and the second filter region, wherein the first edge portion, the second edge portion, and the partitioning portion are integrally combined.

Further, one or more of the first filter region and the second filter region may include a sub region in which one of the different types of filter members is supported and a main region in which another of the different types of filter members is supported, to stack and support the different types of filter members.

Further, one or more of the first edge portion, the second edge portion, and the partitioning portion may include a stepped portion formed between the sub region and the main region, and the stepped portion may extend along at least a perimeter of one or more of the first filter region and the second filter region.

Further, a height of the partitioning portion may be greater than at least one of a thickness of the sub region in a front and rear direction and a thickness of the main region in the front and rear direction.

Further, the thickness of the sub region in the front and rear direction may be smaller than the thickness of the main region in the front and rear direction, and the height of the partitioning portion may be greater than the thickness of the sub region in the front and rear direction and smaller than the thickness of the main region in the front and rear direction.

Further, a plurality of wall portions may be spaced apart from each other on a rear surface of the partitioning portion to form a groove.

Further, at least some of the plurality of wall portions may be in contact with some of the plurality of filter members of different types, respectively.

Further, an air purifier may include: the filter assembly described above; a frame supporting the filter assembly; and a fan assembly providing a blowing force to move air from an outside of the frame to an inside of the frame.

Further, the fan assembly may include a first fan unit and a second fan unit, the first fan unit may guide the air to pass through the first filter region of the filter assembly, and the second fan unit may guide the air to pass through the second filter region of the filter assembly.

Further, a plurality of wall portions may be spaced apart on a rear surface of the partitioning portion to form a groove, and the frame may include a plurality of protruding ribs that extend toward the partitioning portion, and the plurality of protruding ribs project toward an inner side of the groove or toward the first filter region and the second filter region outside the groove.

Further, a plurality of wall portions may be spaced apart on a rear surface of the partitioning portion to form a groove, the frame may include a protruding rib extending toward the partitioning portion, and the protruding rib may include a plurality of protruding ribs that protrude to face the plurality of wall portions.

In accordance with another aspect of the present disclosure, there is provided an air purifier including: a frame; a filter assembly detachably mounted on the frame for filtering air; a fan assembly providing a blowing force to move air from an outside of the frame to an inside of the frame; and a controller for controlling an operation of the fan assembly, wherein the filter assembly includes: a plurality of filter members of different types; and a filter holder supporting the plurality of filter members and including a first filter region and a second filter region which are separate from each other, wherein a portion of the plurality of filter members is supported by the filter holder in the first filter region, and another portion of the plurality of filter members is supported by the filter holder in the second filter region, wherein the fan assembly includes: a first fan unit for guiding the air to pass through the first filter region; and a second fan unit for guiding the air to pass through the second filter region, wherein an air resistance value for the portion of the filter members supported in the first filter region differs from an air resistance value for the portion of the filter members supported in the second filter region, and wherein the controller controls the fan assembly such that the first fan unit operates at a higher rotation speed than the second fan unit.

Further, the first filter region may be mounted in the frame to be disposed below the second filter region.

Further, the plurality of filter members may include a first filter member including a HEPA filter and a second filter member including a deodorization filter, the first filter member may include a plurality of first filter members, and one of the plurality of first filter members may be supported in the first filter region along with the second filter member, and another of the plurality of first filter members may be supported in the second filter region.

Further, the plurality of filter members may further include a third filter member of a type different from the first filter member and the second filter member, and the third filter member may be supported by the filter holder in the second filter region along with the other first filter member.

Further, the filter holder may include: an edge portion surrounding and supporting edges of the plurality of filter members; and a rib portion that prevents at least some of the plurality of filter members supported by the edge portion from becoming detached from the edge portion, and the rib portion may extend from the edge portion toward one or more of the first filter region and the second filter region.

Further, the filter holder may include: an edge portion surrounding and supporting edges of the plurality of filter members; and a gripping portion provided on an outer circumferential surface of the edge portion, and the gripping portion may be made of a flexible material to be disposed between the filter holder and the frame when the filter assembly is mounted in the frame.

Further, the filter holder may include an edge portion surrounding and supporting edges of the plurality of filter members, and, when viewed in an up and down direction, the edge portion may have at least a portion of each of both ends in a left and right direction tapered in shape.

Further, the edge portion, when viewed in the left and right direction, may have at least a portion of one end of both ends tapered in shape in the up and down direction, while the other end has a slope different from that of the one end.

Further, the frame may have an inlet for allowing the air to flow into the inside of the frame and an outlet for discharging the air from the inside of the frame to the outside of the frame, and the outlet may be formed at an upper portion of the frame, and the inlet is formed at a side surface of the frame.

### Effect of Invention

According to one embodiment of the present disclosure, it is possible to mount or detach various types of filters into or from the frame simultaneously.

Furthermore, according to one embodiment of the present disclosure, the filter assembly can be prevented from being mounted into the frame in an incorrect orientation.

Additionally, according to one embodiment of the present disclosure, by controlling the first fan unit, which faces a first filter region, to operate at a higher rotational speed than a second fan unit, even if a higher differential pressure is applied to the first filter region than to the second filter region, air can smoothly pass through the first filter region.

Moreover, according to one embodiment of the present disclosure, a plurality of wall portions are supported by the protruding ribs of a frame, thereby preventing vortex formation between the filter assembly and the frame.

### BRIEF DESCRIPTION OF THE DRAWINGS

FIG. 1 is a perspective view of an air purifier according to a first embodiment of the present disclosure.

FIG. 2 is an exploded perspective view of the air purifier shown in FIG. 1.

FIG. 3 is a front view of the frame shown in FIG. 2.

FIG. 4 is an exploded perspective view of the filter assembly shown in FIG. 2.

FIG. 5 is a rear perspective view of a filter holder shown in FIG. 4.

FIG. 6 is a cross sectional view taken along line VI-VI of FIG. 4.

FIG. 7 is a plan view and partial enlarged view of the filter holder shown in FIG. 4.

FIG. 8 is a left side view of the filter holder shown in FIG. 4.

FIG. 9 is a cross sectional view taken along line IX-IX of FIG. 1.

FIG. 10 is an exploded perspective view of a filter assembly according to a second embodiment of the present disclosure.

### BEST MODE FOR CARRYING OUT THE INVENTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, ‘supported’ by, or ‘coupled’ to, another element, it should be understood that the element may be directly connected to, supported by, or coupled to another element, but that other elements may exist in the middle.

The terms used in the present disclosure are only used for describing specific embodiments, and are not intended to limit the present disclosure. Singular expressions include plural expressions unless the context clearly indicates otherwise.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Further, in the present disclosure, it is to be noted that expressions, such as the upper side and the lower side, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Hereinafter, an air purifier 1 according to one embodiment of the present disclosure will be described with reference to the drawings.

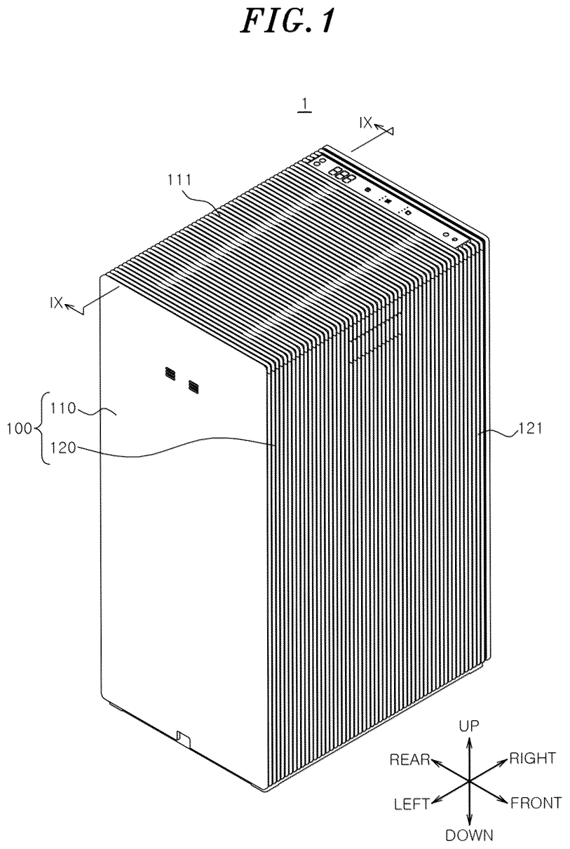

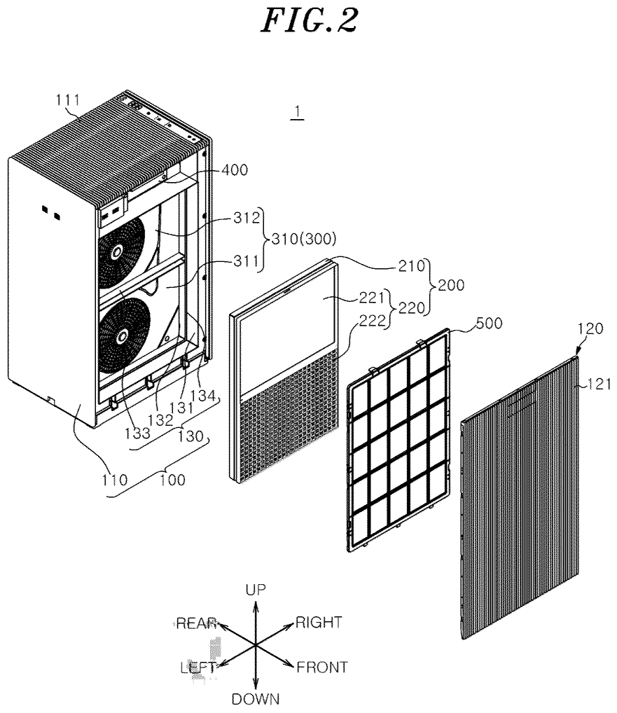

Referring to FIGS. 1 and 2, an air purifier 1 according to a first embodiment of the present disclosure is capable of purifying polluted air into clean air by filtering dust, odor particles, and the like from air introduced into an interior of the air purifier 1. The air purifier 1 may draw in external air into an interior thereof and discharge a clean air that has been purified to an outside. Such an air purifier 1 may include a frame 100, a filter assembly 200, a fan assembly 300, a controller 400, and a pre filter 500.

The frame 100 may support the filter assembly 200 and the fan assembly 300. Additionally, the frame 100 may support the filter assembly 200 such that the filter assembly 200 is replaceably mounted. The frame 100 may include a body frame 110, a cover frame 120, and a support frame 130.

The body frame 110 may support the filter assembly 200 and the fan assembly 300. For example, the body frame 110 may have a predetermined space formed therein and may support the filter assembly 200 and the fan assembly 300 arranged inside thereof. An outlet 111 for discharging air introduced into the frame 100 to the outside may be formed in the body frame 110. The outlet 111 may be disposed on an upper surface of the body frame 110.

The cover frame 120 may be detachably coupled to the body frame 110. The cover frame 120 may cover both front and rear sides of the body frame 110. Further, an inlet 121 through which external air is introduced into the frame 100 may be formed in the cover frame 120.

Meanwhile, a plurality of cover frames 120 may be provided, and the plurality of cover frames 120 may be coupled to both sides of the body frame 110. For example, the plurality of cover frames 120 may be coupled to the front and rear surfaces of the frame 100, allowing external air to be introduced from both front and back sides of the frame 100.

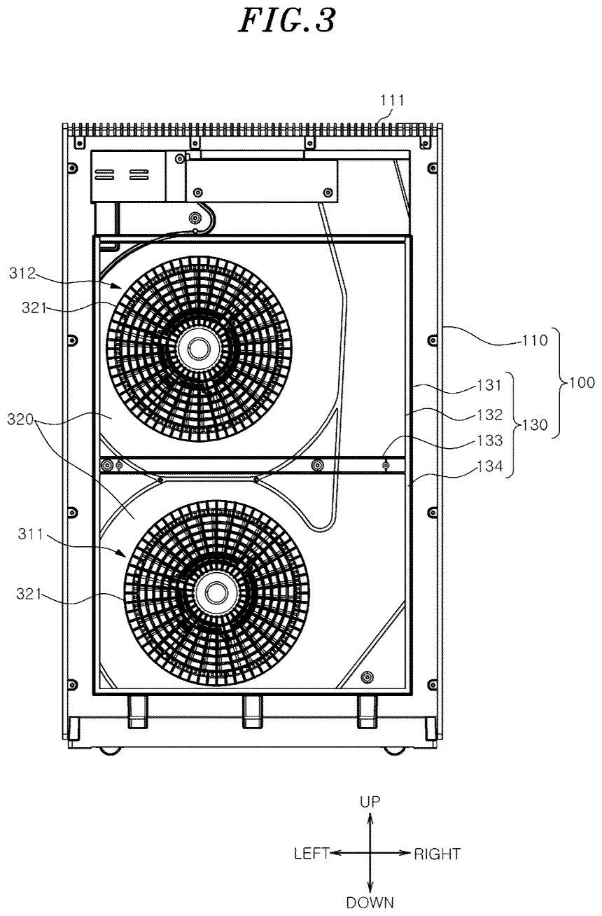

Referring to FIGS. 2 and 3, the support frame 130 may support the filter assembly 200 and may be configured so that the filter assembly 200 is removably mounted. In addition, the support frame 130 may be disposed on the inside of the body frame 110 and may be arranged on both front and rear sides of the fan assembly 300. The support frame 130 may include a first support 131, a second support 132, a protruding rib 133, and a frame step 134.

The first support 131 may support an outer peripheral surface of the filter holder 210 when the filter assembly 200 is mounted on the frame 100. For example, the first support 131 may support an upper, lower, left, and right surfaces of each of edge portions 211 and 212 described later when the filter assembly 200 is mounted on the frame 100.

The second support 132 may support at least a portion of the filter holder 210 when the filter assembly 200 is mounted in the frame 100. For example, the second support 132 may support the edge of the first edge portion 211 to be described later when the filter assembly 200 is mounted on the frame 100. The second support 132 may extend outward from the fan housing 320 toward the outside of the frame 100.

The protruding rib 133 may support the partitioning portion 213 of the filter holder 210, as described later. For example, a plurality of protruding ribs 133 may be provided, and the plurality of protruding ribs 133 may support a plurality of wall portions 213a when the filter assembly 200 is mounted in the frame 100. In this case, the plurality of protruding ribs 133 may come into close contact with the plurality of wall portions 213a and form an airflow path with the plurality of wall portions 213a. Further, the plurality of protruding ribs 133 may protrude to face the plurality of wall portions 213a when the filter assembly 200 is mounted in the frame 100. However, this is merely exemplary, and the protruding ribs 133 may protrude toward grooves between the wall portions 213a or toward a first filter region 210a and a second filter region 210b.

The frame step 134 may prevent the filter assembly 200 from being excessively inserted into the inside of the frame 100 when the filter assembly 200 is mounted in the frame 100. For example, when the filter assembly 200 is mounted in the frame 100, the filter assembly 200 may be caught by the frame step 134. In this case, the filter assembly 200 does not come into close contact with the fan housing 320 and may be spaced apart from the fan housing 320. The frame step 134 may be formed in at least one of the first support 131 and the second support 132.

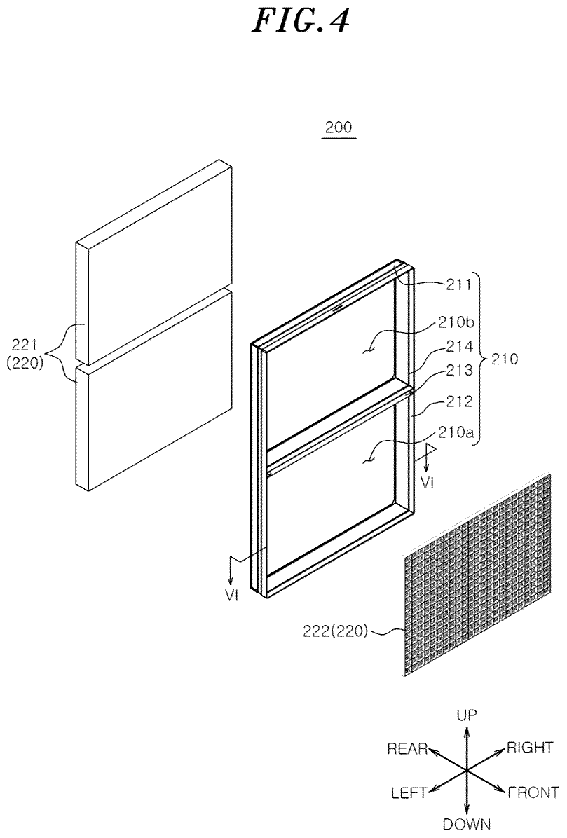

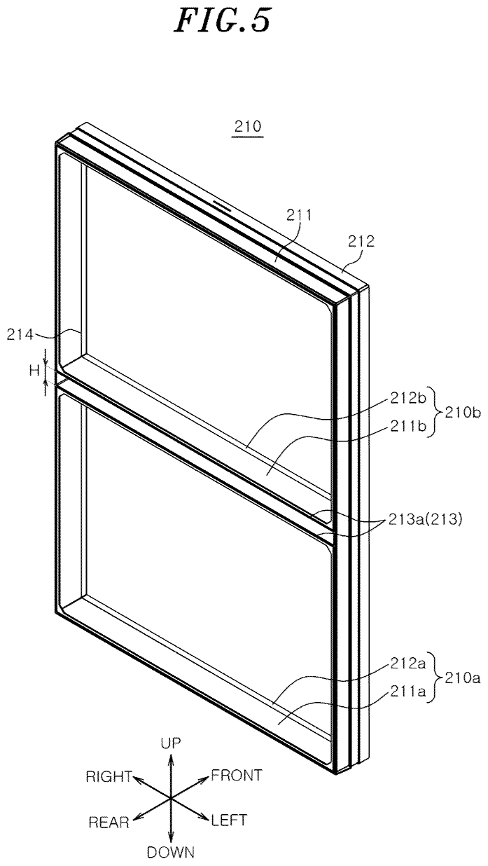

Referring to FIGS. 4 and 5, the filter assembly 200 may filter external air into clean air. The filter assembly 200 may be detachably mounted in the frame 100. For example, after a certain period of use, the filter assembly 200 may be replaced with a new one. Additionally, a plurality of filter assemblies 200 may be provided, and these may be arranged on both sides of the frame 100. For example, the plurality of filter assemblies 200 may be disposed in the front and rear sides of the frame 100, allowing filtration of air introduced from both the front and rear sides of the frame 100. The filter assembly 200 may include a filter holder 210 and a filter unit 220.

The filter holder 210 may support the filter unit 220 and may be mounted on the frame 100. Additionally, the filter holder 210 may be provided to enclose the filter unit 220. The filter holder 210 may include a first filter region 210a and a second filter region 210b.

In the first filter region 210a, a first filter member 221 and a second filter member 222 may be placed together. In this case, in the first filter region 210a, the first filter member 221 and the second filter member 222 may be arranged in a thickness direction of the filter holder 210. The first filter region 210a may include a first main region 211a and a first sub region 212a, where different types of filter members 221, 222, and 223 are arranged.

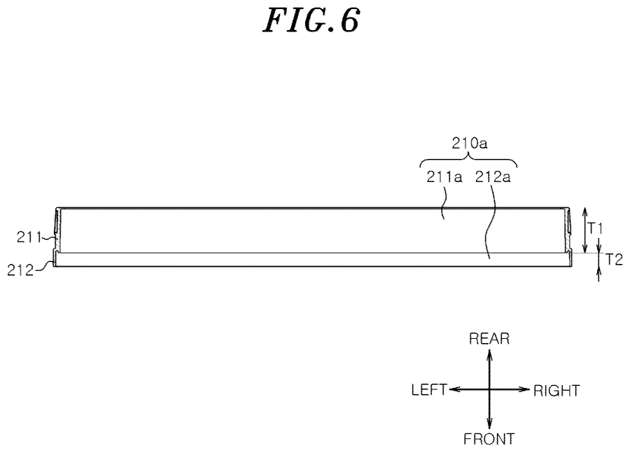

The first main region 211a may accommodate the first filter member 221, and the first sub region 212a may accommodate the second filter member 222. Additionally, the first main region 211a and the first sub region 212a may be arranged in the thickness direction of the filter holder 210. For instance, when the filter assembly 200 is mounted on the frame 100, the first main region 211a may be positioned closer to the inside of the frame 100 than the first sub region 212a. Further, referring to FIG. 6, a thickness T1 of the first main region 211a in a front and rear direction may be greater than a thickness T2 of the first sub region 212a in the front and rear direction.

Referring again to FIGS. 4 and 5, in the second filter region 210b, the first filter member 221 and the third filter member 223 may be placed together. In this case, the second filter region 210b may have the first filter member 221 and the third filter member 223 arranged in the thickness direction of the filter holder 210. Additionally, a differential pressure between air before passing through the second filter region 210b and air after passing through the second filter region 210b may differ from a differential pressure between air before passing through the first filter region 210a and air after passing through the first filter region 210a. For example, the differential pressure by the second filter region 210b may be lower than the differential pressure the first filter region 210a.

Furthermore, when the filter assembly 200 is mounted in the frame 100, the second filter region 210b may be positioned above the first filter region 210a. The second filter region 210b may also include a second main region 211b and a second sub region 212b, where different types of filter members 221, 222, and 223 are arranged.

The second main region 211b may accommodate the first filter member 221, and the second sub region 212b may accommodate the third filter member 223. In addition, the second main region 211b and the second sub region 212b may be arranged in the thickness direction of the filter holder 210. For example, when the filter assembly 200 is mounted in the frame 100, the second main region 211b may be positioned closer to the inside of the frame 100 than the first sub region 212a. Referring to FIG. 6, a thickness T1 of the second main region 211b in the front and rear direction may be greater than a thickness T2 of the second sub region 212b in the front and rear direction.

While the present specification describes the first filter region 210a and the second filter region 210b as having the main regions 211a and 211b and the sub regions 212a and 212b, respectively, this is merely exemplary and does not limit the present disclosure. Therefore, one or more of the first filter region 210a and the second filter region 210b may include the main regions 211a and 211b and the sub regions 212a and 212b. For example, only the first filter region 210a may include the main region 211a and the sub region 212a.

Meanwhile, the filter holder 210 may include a first edge portion 211, a second edge portion 212, a partitioning portion 213, and a step 214.

The first edge portion 211 surrounds and supports the first filter member 221. The first edge portion 211 may form at least part of the first filter region 210a and at least part of the second filter region 210b. For example, the first edge portion 211 may form the first main region 211a of the first filter region 210a and the second main region 211b of the second filter region 210b. Additionally, when the filter assembly 200 is mounted in the frame 100, the first edge portion 211 may be supported by the first support 131 and the second support 132.

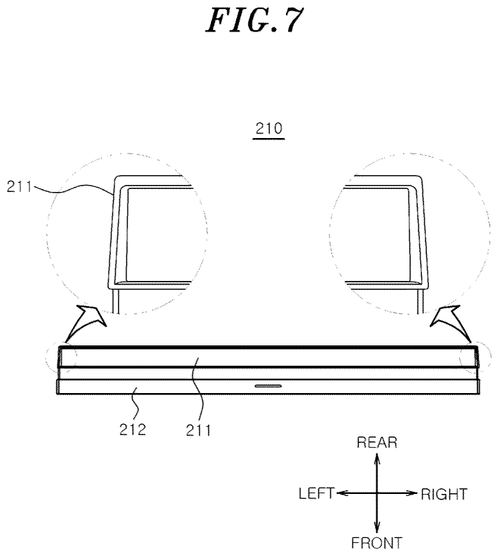

Referring to FIG. 7, the first edge portion 211 may have a tapered shape in at least a portion of each of both ends thereof in a left and right direction when viewed in an up and down direction. For instance, when the filter assembly 200 is mounted in the frame 100 and viewed in the up and down direction, both ends of the first edge portion 211 in the left and right direction may spread outward toward the outside of the frame 100. In this case, the filter assembly 200 can be prevented from being mounted on the frame 100 with the second edge portion 212 positioned more inward than the first edge portion 211 in the frame 100. In other words, when the filter assembly 200 is mounted on the frame 100 with the second edge portion 212 positioned more inward than the first edge portion 211, both ends of the first edge portion 211 in the left and right direction interfere with the support frame 130.

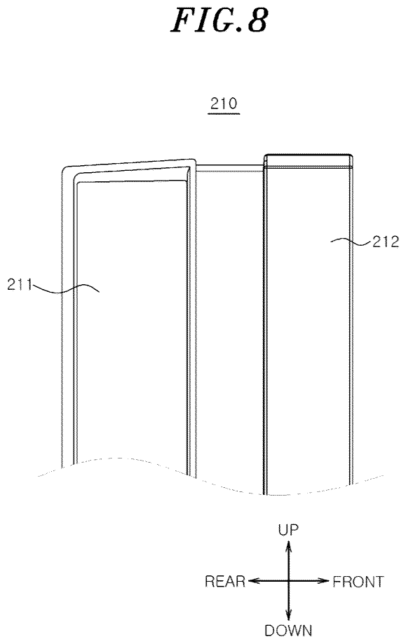

Referring to FIG. 8, among both ends of the first edge portion 211 in the up and down direction, when viewed in the left and right direction, one end has a tapered shape and the other end has a different slope from the one end. For example, the first edge portion 211, when viewed from the left and right direction, may have upper and lower ends that are tapered with different inclines. In this case, the filter assembly 200 may be prevented from being mounted to the frame 100 with the first filter region 210a disposed upward of the second filter region 210b. In other words, when the filter assembly 200 is mounted in the frame 100 with the first filter region 210a disposed upward of the second filter region 210b, both upper and lower ends of the first edge portion 211 interfere with the support frame 130.

The second edge portion 212 surrounds and supports the second filter member 222 and the third filter member 223. The second edge portion 212 may form at least part of the first filter region 210a and at least part of the second filter region 210b. For example, the second edge portion 212 may form the first sub region 212a of the first filter region 210a and the second sub region 212b of the second filter region 210b. Additionally, when the filter assembly 200 is mounted in the frame 100, the second edge portion 212 may be positioned outward of the frame 100 than the first edge portion 211.

Referring again to FIG. 5, the partitioning portion 213 may partition the first filter region 210a and the second filter region 210b. The partitioning portion 213 may be formed to extend across the first edge portion 211 and the second edge portion 212 with a predetermined width. Further, the partitioning portion 213 may be integrally coupled with the first edge portion 211 and the second edge portion 212. The partitioning portion 213 may have a predetermined height H in the up and down direction, which may be greater than at least one of the thickness T1 in the front and rear direction of the first main region 211a and the thickness T2 in the front and rear direction of the first sub region 212a. For example, the height H of the partitioning portion 213 may be smaller than the thickness T1 in the front and rear direction of the first main region 211a and greater than the thickness T2 in the front and rear direction of the first sub region 212a. The partitioning portion 213 may be positioned at the center of the filter holder 210 and may support the filter unit 220. Additionally, the partitioning portion 213 may include a wall portion 213a.

The wall portion 213a may partition the first filter region 210a and the second filter region 210b. The wall portion 213a may include a plurality of wall portions 213a and the plurality of wall portions 213a may be spaced apart in the up and down direction in a rear surface of the partitioning portion 213 so that grooves are formed. Further, at least some of the plurality of wall portions 213a may each be in contact with some of the different types of filter members 221, 222, and 223. For example, among the plurality of wall portions 213a, the wall portion 213a positioned in the lower side may contact the first filter member 221 and the second filter member 222, and the wall portion 213a positioned in the upper side may contact the first filter member 221 and the third filter member 223. The partitioning portion 213 may be supported by the protruding rib 133 when the filter assembly 200 is mounted in the frame 100.

Referring again to FIG. 4, the step 214 may engage with the second filter member 222 and the third filter member 223. The step 214 may be formed on one or more of the edge portions 211 and 212 and the partitioning portion 213. For example, the step 214 may be formed between the first edge portion 211 and the second edge portion 212, and may be formed in an upper portion of the partitioning portion 213. Further, the step 214 may be formed in the first filter region 210a and the second filter region 210b. The step 214 formed in the first filter region 210a may be formed along a periphery of the first filter region 210a, and the step 214 formed in the second filter region 210b may extend along a periphery of the second filter region 210b.

However, this is merely an example, and the step 214 may be formed on at least one of the first filter region 210a and the second filter region 210b. For example, the step 214 may be formed only in the first filter region 210a. In this case, the step 214 may extend along the periphery of the first filter region 210a.

The filter unit 220 may filter out contaminants from flowing air and filter external air into clean air. For example, the filter unit 220 may include known filters, such as a HEPA filter or a deodorization filter, to filter out dust, odor particles, etc., from the air. The filter unit 220 may include the plurality of filter members 221, 222, and 223.

The plurality of filter members 221, 222, 223 may include the first filter member 221, the second filter member 222, and the third filter member 223.

The first filter member 221 may be provided to filter out dust from air. For example, the first filter member 221 may include a HEPA filter. Also, the first filter member 221 may include a plurality of first filter members 221. Some of the plurality of first filter members 221 may be placed in the first filter region 210a and others of the plurality of first filter members 221 may be placed in the second filter region 210b. Additionally, the first filter member 221 may be arranged to face the fan assembly 300 when the filter assembly 200 is mounted in the frame 100.

The second filter member 222 may be provided to filter odor particles from air. For example, the second filter member 222 may include a carbon filter. The second filter member 222 may be placed in the first filter region 210a. Additionally, the second filter member 222 may be arranged to face the cover frame 120 when the filter assembly 200 is mounted in the frame 100.

The third filter member 223 may be a different type of filter from the first and second filter members 221 and 222 and may be a functional filter that provides various functions. For example, the third filter member 223 may be an antibacterial filter capable of sterilizing microorganisms in air. However, although the third filter member 223 is described as an antibacterial filter in the present specification, it is merely an example, and the third filter member 223 may be a known filter that provides various functions. The third filter member 223 may be placed in the second filter region 210b. Additionally, the third filter member 223 may be arranged to face the cover frame 120 when the filter assembly 200 is mounted in the frame 100.

Meanwhile, an air resistance value for certain filter members 221 and 222 supported in the first filter region 210a may differ from an air resistance value for other filter members 221 and 223 supported in the second filter region 210b. For example, the air resistance value for the first filter member 221 and the second filter member 222 supported in the first filter region 210a may be greater than the air resistance value for the first filter member 221 and the third filter member 223 supported in the second filter region 210b.

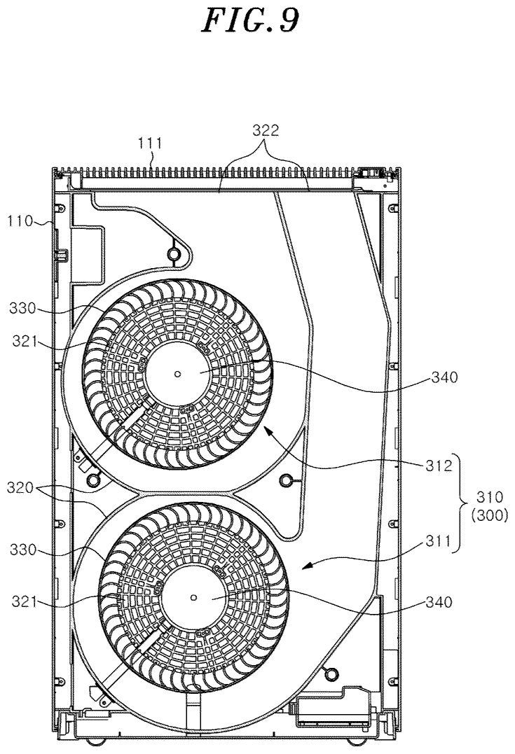

Referring to FIG. 9, the fan assembly 300 may provide blowing power to flow external air into the frame 100. The fan assembly 300 may include a plurality of fan units 310. The plurality of fan units 310 may include a first fan unit 311 and a second fan unit 312, arranged in the up and down direction.

The first fan unit 311 may flow air toward the first filter region 210a. The first fan unit 311 may be disposed below the second fan unit 312. Additionally, the first fan unit 311 may face the first filter region 210a when the filter assembly 200 is mounted in the frame 100.

The second fan unit 312 may flow air toward the second filter region 210b. The second fan unit 312 may face the second filter region 210b when the filter assembly 200 is mounted in the frame 100.

The first fan unit 311 and the second fan unit 312 may each include a fan housing 320, a fan 330, and a fan motor 340.

The fan housing 320 may accommodate the fan 330 and the fan motor 340. The fan housing 320 may be supported by the body frame 110. The fan housing 320 may have an intake port 321 through which air is drawn into the fan housing 320 and an outlet 322 through which the air drawn into the fan housing 320 is discharged.

The fan 330 may rotate about a rotation axis extending in the front and rear direction. The fan 330 may be driven by the fan motor 340.

The fan motor 340 may rotate the fan 330, and the operation of the fan motor 340 may be controlled by the controller 400.

The controller 400 may control the operation of the fan assembly 300. The controller 400 may control the first fan unit 311 and the second fan unit 312 to operate differently. For example, the controller 400 may control the first fan unit 311 and the second fan unit 312 such that the first fan unit 311 operates at a higher rotational speed (rpm) than the second fan unit 312. The controller 400 may be implemented with an electrical circuit board including a processor, a memory, and the like. The controller 400 may be implemented by a computing device including a microprocessor, a measurement device such as a sensor, and memory, the implementation method of which will be apparent to those skilled in the art and will not be described in further detail.

The pre filter 500 may primary filter contaminants in air before the air is filtered in the filter assembly 200. The pre filter 500 may be disposed between the cover frame 120 and the filter assembly 200, and external air may be passed through the pre filter 500 before passing through the fan assembly 300. For example, the external air may pass sequentially through the inlet 121, the pre filter 500, the filter assembly 200, and the fan assembly 300.

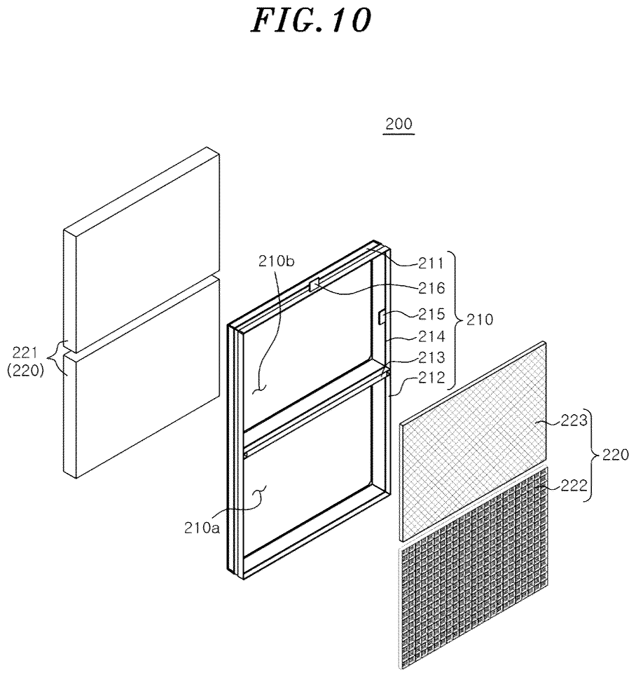

In addition to the aforementioned configuration, according to-second embodiment of the present disclosure, the filter holder 210 may further include a rib portion 215 and a gripping portion 216. Hereinafter, the second embodiment of the present disclosure will be described with reference to FIG. 10. In describing the second embodiment, emphasis is placed on differences from the previously described embodiment, with the same descriptions and reference numbers being used as in the preceding embodiment.

The rib portion 215 may prevent the second filter member 222 and the third filter member 223, supported by the second edge portion 212, from detaching from the second edge portion 212. This rib portion 215 may extend from the second edge portion 212 toward an inner side of the second edge portion 212.

The gripping portion 216 may be provided on either the first edge portion 211 or the second edge portion 212 to allow a user to easily grip the filter assembly 200. The gripping portion 216 may be made of a flexible material so that it can be positioned between the second edge portion 212 and the support frame 130 when the filter assembly 200 is mounted in the frame 100.

As described above, according to the embodiments of the present disclosure, the filter assembly 200 allows various types of filter members 221, 222, and 223 to be supported by the single filter holder 210, enabling the plurality of filter members 221, 222, and 223 to be attached to or detached from the frame 100 at once. In this case, transporting the plurality of filter members 221, 222, and 223 is convenient, and they can be easily replaced from the frame 100.

Furthermore, the filter assembly 200 can be directionally mounted on the frame 100 due to the tapered shape of the edge portions 211 and 212 of the filter holder 210. In this case, it is possible to prevent the filter assembly 200 from being mounted on the frame 100 such that the first filter member 221 is disposed on an outer side of the frame 100 than the second filter member 222. Further, it is possible to prevent the filter assembly 200 from being mounted in the frame 100 such that the second filter member 222 is positioned above the third filter member 223.

Meanwhile, according to the embodiments of the present disclosure, the air purifier 1 can prevent vortex formation between the filter assembly 200 and the frame 100 by supporting the plurality of wall portions 213a with the protruding rib 133 of the frame 100. In this case, air that has passed through the filter assembly 200 can flow smoothly toward the fan assembly 300 without remaining between the filter assembly 200 and the frame 100.

Further, the air purifier 1 controls the first fan unit 311, which faces the first filter region 210a, to operate at a higher rotational speed than the second fan unit 312. Accordingly, even if a higher differential pressure is applied to the first filter region 210a than to the second filter region 210b, air can flow smoothly through the first filter region 210a. 5

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed 10 embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A filter assembly comprising:
a plurality of filter members of different types for filtering contaminants from flowing air; and
a filter holder supporting the plurality of filter members and including a first filter region and a second filter region that are separated without overlapping when viewed in a direction of air flow,
wherein the filter holder includes:
a first edge portion forming at least a portion of the first filter region;
a second edge portion forming at least a portion of the second filter region; and
a partitioning portion dividing the first filter region and the second filter region, and
wherein the first edge portion, the second edge portion, and the partitioning portion are integrally combined.

2. The filter assembly of claim 1, wherein one or more of the first filter region and the second filter region include a sub region in which one of the different types of filter members is supported and a main region in which another of the different types of filter members is supported, to stack and support the different types of filter members.

3. The filter assembly of claim 2, wherein one or more of the first edge portion, the second edge portion, and the partitioning portion includes a stepped portion formed between the sub region and the main region, and
wherein the stepped portion extends along at least a perimeter of one or more of the first filter region and the second filter region.

4. The filter assembly of claim 2, wherein a height of the partitioning portion is greater than at least one of a thickness of the sub region in a front and rear direction and a thickness of the main region in the front and rear direction.

5. The filter assembly of claim 4, wherein the thickness of the sub region in the front and rear direction is smaller than the thickness of the main region in the front and rear direction, and the height of the partitioning portion is greater than the thickness of the sub region in the front and rear direction and smaller than the thickness of the main region in the front and rear direction.

6. The filter assembly of claim 1, wherein a plurality of wall portions are spaced apart from each other on a rear surface of the partitioning portion to form a groove.

7. The filter assembly of claim 6, wherein at least some of the plurality of wall portions are in contact with some of the plurality of filter members of different types, respectively.

8. An air purifier comprising:
the filter assembly of claim 1;
a frame supporting the filter assembly; and
a fan assembly providing a blowing force to move air from an outside of the frame to an inside of the frame.

9. The air purifier of claim 8, wherein the fan assembly includes a first fan unit and a second fan unit,
wherein the first fan unit guides the air to pass through the first filter region of the filter assembly, and
wherein the second fan unit guides the air to pass through the second filter region of the filter assembly.

10. The air purifier of claim 8, wherein a plurality of wall portions are spaced apart on a rear surface of the partitioning portion to form a groove, and
wherein the frame includes a plurality of protruding ribs that extend toward the partitioning portion, and the plurality of protruding ribs project toward an inner side of the groove or toward the first filter region and the second filter region outside the groove.

11. The air purifier of claim 8, wherein a plurality of wall portions are spaced apart on a rear surface of the partitioning portion to form a groove,
wherein the frame includes a protruding rib extending toward the partitioning portion, and
wherein the protruding rib includes a plurality of protruding ribs that protrude to face the plurality of wall portions.

12. An air purifier comprising:
a frame;
a filter assembly detachably mounted in the frame for filtering air;
a fan assembly providing a blowing force to move air from an outside of the frame to an inside of the frame; and
a controller for controlling an operation of the fan assembly,
wherein the filter assembly includes:
a plurality of filter members of different types; and
a filter holder supporting the plurality of filter members and including a first filter region and a second filter region which are separate from each other,
wherein a portion of the plurality of filter members is supported by the filter holder in the first filter region, and another portion of the plurality of filter members is supported by the filter holder in the second filter region,
wherein the fan assembly includes:
a first fan unit for guiding the air to pass through the first filter region; and
a second fan unit for guiding the air to pass through the second filter region,
wherein an air resistance value for the portion of the filter members supported in the first filter region differs from an air resistance value for the portion of the filter members supported in the second filter region, and
wherein the controller controls the fan assembly such that the first fan unit operates at a higher rotation speed than the second fan unit.

13. The air purifier of claim 12, wherein the first filter region is mounted in the frame to be disposed below the second filter region.

14. The air purifier of claim 12, wherein the plurality of filter members include a first filter member including a HEPA filter and a second filter member including a deodorization filter,
wherein the first filter member includes a plurality of first filter members, and
wherein one of the plurality of first filter members is supported in the first filter region along with the second filter member, and another of the plurality of first filter members is supported in the second filter region.

15. The air purifier of claim 14, wherein the plurality of filter members further include a third filter member of a type different from the first filter member and the second filter member, and
wherein the third filter member is supported by the filter holder in the second filter region along with the other first filter member.

16. The air purifier of claim 12, wherein the filter holder includes:
an edge portion surrounding and supporting edges of the plurality of filter members; and
a rib portion that prevents at least some of the plurality of filter members supported by the edge portion from becoming detached from the edge portion,
wherein the rib portion extends from the edge portion toward one or more of the first filter region and the second filter region.

17. The air purifier of claim 12, wherein the filter holder includes:
an edge portion surrounding and supporting edges of the plurality of filter members; and
a gripping portion provided on an outer circumferential surface of the edge portion, and
wherein the gripping portion is made of a flexible material to be disposed between the filter holder and the frame when the filter assembly is mounted in the frame.

18. The air purifier of claim 12, wherein the filter holder includes an edge portion surrounding and supporting edges of the plurality of filter members, and
wherein, when viewed in an up and down direction, the edge portion has at least a portion of each of both ends in a left and right direction tapered in shape.

19. The air purifier of claim 18, wherein the edge portion, when viewed in the left and right direction, includes at least a portion of one end of both ends tapered in shape in the up and down direction, and the other end that has a slope different from a slope of the one end.

20. The air purifier of claim 12, wherein the frame has an inlet for allowing the air to flow into the inside of the frame and an outlet for discharging the air from the inside of the frame to the outside of the frame, and
wherein the outlet is formed at an upper portion of the frame, and the inlet is formed at a side surface of the frame.
